(19) United States
(12) Patent Application Publication
(10) Pub. No.: US 2023/0280885 A1
(43) Pub. Date: Sep. 7, 2023

(54) GRAPHICAL USER INTERFACE GENERATION AND CONTENT DELIVERY SYSTEMS AND METHODS

(71) Applicant: Promethean Limited, Blackburn (GB)

(72) Inventors: Emily Bruton, Redmond, WA (US); Heather Elsa, Seattle, WA (US); Rachel Ashmore, Stonnall (GB); Robert Hudson, Milton, GA (US); Stephanie Allen, Pompano Beach, FL (US); Anna Hughes, Seattle, WA (US)

(73) Assignee: Promethean Limited, Blackburn (GB)

(21) Appl. No.: 18/117,022

(22) Filed: Mar. 3, 2023

Related U.S. Application Data
(60) Provisional application No. 63/316,824, filed on Mar. 4, 2022.

(51) Int. Cl. G06F 3/0484; G06F 3/0482

(52) U.S. Cl. CPC G06F 3/0484; G06F 3/0482

(57) ABSTRACT

A user interface configuration system, according to various embodiments, is configured to provide a centralized interface containing a plurality of user-defined content in the form of content blocks. In various embodiments, the system is configured to automatically access particular content blocks according to one or more time constraints. For example, the user interface configuration system may enable a user to configure a day's worth of lessons in the form of individual content blocks. In particular embodiments, each individual content block may include a set of content (i.e., documents, applications, links, videos, images, etc.) that must be accessible during presentation of the content block. Such an arrangement reduces cumbersome, time-consuming processes for navigating to different pieces of content stored on, or otherwise accessible from different locations that requires the use of arbitrary commands to access by providing a single interface defined by required content and time constraints.

### CROSS-REFERENCE TO RELATED APPLICATIONS

This application claims the benefit of U.S. Provisional Patent Application Ser. No. 63/316,824, filed Mar. 4, 2022, which is hereby incorporated herein by reference in its entirety.

### TECHNICAL FIELD

This disclosure relates generally to computer-implemented methods and systems for computer graphics processing and data processing. More specifically, and not by way of limitation, the disclosure relates to customized user interface generation and content delivery systems.

### BACKGROUND

A significant technical challenge encountered in the context of providing efficient functioning of a computer is generating and configuring user interfaces for electronic devices that improve the efficiency of use of the electronic devices for a user. Automating user interfaces according to the needs of a user can present technical challenges related to the generation and configuration of such interfaces, particularly when requiring frequent switching between software applications, documents, and other different forms of computer functionality. Accordingly, there is a need for systems and methods that address these difficulties in addition to other deficiencies found in prior art systems.

### SUMMARY

In general, various aspects of the present disclosure provide methods, apparatuses, systems, computing devices, computing entities, and/or the like for generating customized user interfaces. In accordance with various aspects, a system is provided comprising a non-transitory computer-readable medium storing instructions and processing hardware communicatively coupled to the non-transitory computer-readable medium. The processing hardware is configured to execute the instructions and thereby perform operations comprising: (1) receiving user-defined content data for each of a plurality of content blocks, the user-defined content data including at least one respective piece of content for each of the plurality of content blocks and a respective time constraint for each of the plurality of content blocks; (2) generating a graphical user interface that includes the plurality of content blocks by arranging the plurality of content blocks according to each respective time constraint such that: (A) each of the plurality of content blocks is sized according to the respective time constraint; and (B) the plurality of content blocks are arranged linearly; (3) configuring each of the plurality of content blocks to launch a presentation element configured to display the at least one respective piece of content; and (4) providing the graphical user interface for display on a computing device. In some aspects, the plurality of content blocks comprise: (1) a first content block defining a first piece of content and a second piece of content; and (2) a second content block defining a third piece of content and a fourth piece of content. In such aspects, the operations may further comprise launching the first content block by: (1) modifying the graphical user interface to include the presentation element; (2) modifying the graphical user interface to include a first selectable-object configured to launch the first piece of content via the presentation element; and (3) modifying the graphical user interface to include a second selectable-object configured to launch the second piece of content via the presentation element.

In some embodiments, the operations further comprise: (1) receiving, via the graphical user interface, selection of the first selectable-object; and (2) in response to receiving the selection of the first selectable-object, launching the first piece of content and displaying the first piece of content via the presentation element. In some embodiments, the operations further comprise launching the second content block by: (1) modifying the graphical user interface to remove the first selectable-object; (2) modifying the graphical user interface to remove the second selectable-object; (3) modifying the graphical user interface to include a third selectable-object configured to launch the third piece of content via the presentation element; and (3) modifying the graphical user interface to include a fourth selectable-object configured to launch the fourth piece of content via the presentation element. In some aspects, launching the second content block comprises launching the second content block in response to expiration of the respective time constraint for the first content block. In other aspects, the operations comprise modifying the graphical user interface to include a fifth selectable-object configured to launch the fifth piece of content via the presentation element; and launching the second content block comprises persisting the fifth selectable-object on the graphical user interface.

In some aspects, the plurality of content blocks comprise a first set of content blocks corresponding to a first day and a second set of content blocks corresponding to a second day; and generating the set of content blocks such that the set of content blocks are aligned linearly comprises arranging the first set of content blocks and the second set of content blocks in a calendar structure. In various aspects, the operations further comprise: receiving selection of a content block from the first set of content blocks; and responsive to receiving the selection of the content block, obscuring the second set of content blocks on the graphical user interface.

In accordance with various aspects, a method is provided. Accordingly, the method comprises: A method comprising: (1) receiving, by computing hardware, user-defined content data for each of a plurality of content blocks, the user-defined content data including at least one respective piece of content for each of the plurality of content blocks and a respective time constraint for each of the plurality of content blocks; (2) generating, by computing hardware, a graphical user interface that includes the plurality of content blocks by arranging the plurality of content blocks according to each respective time constraint such that: (A) each of the plurality of content blocks is sized according to the respective time constraint; and (B) the plurality of content blocks are arranged in at least one column, the column corresponding to a day's worth of content blocks; (3) configuring, by the computing hardware, each of the plurality of content blocks to launch a presentation element configured to display the at least one respective piece of content; (4) providing, by the computing hardware, the graphical user interface for display on a computing device; and (5) causing the computing device to automatically progress from a first content block of the plurality of content blocks to a second content block of the plurality of content blocks according to each respective time constraint.

In some aspects, the at least one column comprises at least five columns, and each of the at least five columns corresponds to a respective day of the week. In various aspects, the method further comprises: (1) receiving, by the computing hardware, presentation data related to each of the plurality of content blocks during presentation of each of the plurality of content blocks on the computing device; and (2) modifying, by the computing hardware, at least one of the at least one respective piece of content or the respective time constraint for at least one of the plurality of content blocks based on the presentation data. In some aspects, the method comprises modifying the respective time constraint based on the presentation data to increase or decrease the respective time constraint based on a presentation time determined from the presentation data. In some embodiments, modifying the respective time constraint comprises modifying, on the graphical user interface, a size of the at least one of the plurality of content blocks.

In a particular embodiment, the at least one column comprises a first column and a second column. In various embodiments, the method further comprises: (1) receiving, via the graphical user interface, selection of a particular content block of the plurality of content blocks; and (2) in response to receiving the selection: (A) modifying the graphical user interface to include the presentation element; (B) identifying a column that includes the particular content block; (C) determining that the particular content block is in the first column; and (D) in response to determining that the particular content block is in the first column, obscuring the second column from the graphical user interface and positioning the first column adjacent the presentation element. In some aspects, obscuring the second column comprises removing the second column from the graphical user interface.

In addition, in accordance with various aspects, a non-transitory computer-readable medium having program code that is stored thereon. The program code executable by one or more processing devices for performing operations comprising: (1) receiving user-defined content data for each of a plurality of content blocks, the user-defined content data including at least one respective piece of content for each of the plurality of content blocks and a respective time constraint for each of the plurality of content blocks; (2) generating a graphical user interface that includes the plurality of content blocks by arranging the plurality of content blocks according to each respective time constraint such that: (A) each of the plurality of content blocks is sized according to the respective time constraint; and (B) the plurality of content blocks are arranged in a calendar structure; (3) configuring each of the plurality of content blocks to launch a presentation element configured to display the at least one respective piece of content; and (4) providing the graphical user interface for display on a computing device.

In some aspects, the operations further comprise causing the computing device to automatically progress through each of the plurality of content blocks according to the calendar structure by launching the presentation element to display the at least one respective piece of content for each individual content block of the plurality of content blocks sequentially based on the respective time constraint such that the presentation element displays the at least one respective piece of content at a time that corresponds to the calendar structure.

In various aspects, the calendar structure comprises a first linear set of content blocks and a second linear set of content blocks; and the operations further comprise: (1) receiving, via the graphical user interface, selection of a particular content block of the plurality of content blocks; and (2) in response to receiving the selection: (A) modifying the graphical user interface to include the presentation element; (B) identifying a linear set of content blocks that includes the particular content block; (C) determining that the particular content block is in the first linear set of content blocks; and (D) in response to determining that the particular content block is in the linear set of content blocks, obscuring the second linear set of content blocks from the graphical user interface and positioning the first linear set of content blocks adjacent the presentation element. In some aspects, obscuring the second linear set of content blocks comprises removing the second linear set of content blocks from the graphical user interface. In some embodiments, the first linear set of content blocks are arranged in at least one or a horizontal row or a vertical column.

### BRIEF DESCRIPTION OF THE DRAWINGS

In the course of this description, reference will be made to the accompanying drawings, which are not necessarily drawn to scale, and wherein:

FIG. 1 depicts an example of a computing environment that can be used for generating and configuring user interfaces in accordance with various embodiments of the present disclosure;

FIG. 2 depicts an example of a process for configuring user interfaces according to various embodiments of the present disclosure;

FIG. 3 depicts an example of a process for presenting and tracking data related to user interfaces in accordance with various embodiments of the present disclosure;

FIG. 4 depicts an example of a process for customizing user interfaces in accordance with various embodiments of the present disclosure;

FIGS. 5-7 depict examples of user interfaces in accordance with various embodiments of the present disclosure;

FIG. 8 depicts an example of a system architecture that may be used in accordance with various embodiments of the present disclosure;

FIG. 9 depicts an example of a computing entity that may be used in accordance with various embodiments of the present disclosure; and

FIGS. 10-13 depict examples of user interfaces in accordance with various embodiments of the present disclosure.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview and Technical Contributions of Various Embodiments

As noted above, a significant challenge encountered in the context of user interface generation is providing efficient access to data and functionality available on a computing device or available to the computing device. A user interface configuration system, according to various embodiments, is configured to provide a centralized interface containing a plurality of user-defined content in the form of content blocks. In various embodiments, the system is configured to automatically access particular content blocks according to one or more time constraints. For example, the user interface configuration system may enable a user (e.g., a teacher, etc.) to configure a day's worth of lessons in the form of individual content blocks. In particular embodiments, each individual content block may include a set of content (i.e., documents, software applications, internet links, videos, images, etc.) that must be accessible during presentation of the content block. Each block of content may, for example, also have a defined block of time (e.g., from 9:00 AM to 10:30 AM) during which the system provides access to the content included in the particular block. For example, a user (e.g., teacher) may add particular content to a content block for a particular lesson. The content may include, for example, video content, audio content, presentation slides, text content, one or more links, particular software applications, etc. In particular embodiments, the system may provide a single interface via which each piece of content (e.g., or set of content) is directly accessible (e.g., during the content block) on the user interface. In various aspects, the system may enable the user to configure each of the content blocks, and the system may then generate a user interface that includes each of a plurality of content blocks representing a schedule for a particular day (e.g., within a particular week). In particular aspects, the user interface defines a calendar structure that includes at least a portion of one or more days of the week. This structure is specifically selected as it is easily identified by users. The structure further enables a user to access each individual piece of content in a set of content defined by a content block during presentation of that content block (e.g., regardless of where each individual piece of content may be accessed). For example, the system may be configured to generate a user interface during presentation of the content block that includes a respective navigational element configured to navigate to, launch, or otherwise access each piece of content in the content block during the presentation. Each navigational element may, for example, include: (1) an executable for launching a software application; (2) a link to a website; (3) a directory address where a particular piece of content is located; (4) a filename and location of a particular document; and/or (5) any other navigational element on the user interface via which a user can access each particular piece of content. In this way, the system is configured to provide a centralized, single interface for accessing a plurality of content (e.g., regardless of type) that makes up a content block, during the presentation thereof.

In particular embodiments, by generating an interface based on a calendar configuration, the system enables the user interfaces to progress between content blocks automatically based on timing constraint data for each block. In this way, the system may further provide centralized access to content for a particular content block (e.g., lesson) at the correct time as defined by the content block time constraints. For example, the system is configured to generate a set of content blocks for a particular day, with each content block having a respective associated timeframe for the day. When generating a user interface for presenting the set of content blocks for the particular day, the system is configured to provide a visual representation of the day's progression through the set of content blocks, while providing access to each piece of content that makes up a particular content block during the time that corresponds to the particular content block's time of day.

As described herein, certain embodiments provide improvements in graphics processing by automatically applying various rules of a particular type, such as constraints and/or timing with respect to particular content blocks, to control the manner in which computing devices dynamically generate user interfaces for presenting media content. For example, these embodiments automatically compute and configure an arrangement of user interfaces for accessing particular portions of content (i.e., sets of content) in a centralized location. Examples of these configuration parameters could include, for example, user interface timing constraints, display constraints, etc. Furthermore, using timing data and content linking defined by a set of rules to generate the user interfaces allows for the dynamic generation of content with a greater degree of automation than provided by conventional solutions. This process reduces or eliminates the need to rely on user inputs (e.g., navigating to desired content, opening the content, displaying the content according to a particular schedule, launching a software program required to access the content, etc.) to manually access particular content and display the content according to a defined schedule.

The automated application of these rules are facilitated by and specifically improve user interface generation. By contrast, conventional techniques for generating user interfaces for displaying content require subjective determinations applied to imprecise manual operations, such as manually checking for a location from which the content is accessible, manually adjusting a layout or content combinations to maintain a presentation schedule for the content, manually navigating to different software applications and sources of content to access and display particular content at a particular time, etc. Thus, embodiments described herein improve computer-implemented processes that are unique to generating user interfaces, thereby providing a more suitable solution for automating tasks previously performed by humans.

Furthermore, certain embodiments provide improvements to computing systems used for generating user interfaces for presenting content by, for example, reducing cumbersome or time-consuming processes for ensuring that content is displayed according to a particular schedule. Still other embodiments reduce cumbersome, time-consuming processes for navigating to different pieces of content stored on, or otherwise accessible from different locations that requires the use of arbitrary commands to access (e.g., copy pasting links from different computer storage locations, navigating to a particular web page that includes the desired content, finding and navigating to a folder on a computing device on which the content is stored, etc.). These problems can be addressed by various user interface features described herein. For instance, a content generation interface, a content presentation interface, or both can include control or navigational elements with functionalities that facilitate the automation of a displaying content according to a particular schedule (e.g., or during a particular time period within a schedule), displaying content from a plurality of different sources simultaneously and/or in order from a centralized location, or some combination thereof. Thus, the structure and associated functionality of the interface features described herein can provide improvements in the field of user interface generation and display.

As described herein, certain embodiments provide improvements to graphical user interface generation by including a specific structure in a generated user interface that provides a specific function derived from that specific structure. For example, in various embodiments, a generated user interface comprises a plurality of content blocks that correspond to a particular calendar structure. The calendar structure may include, for example, a set of content blocks for each day of a particular week. The functionality derived from this specific structure may include the provision, via the graphical user interfaces described herein, access to content block specific content that corresponds to a current day and time from the overall calendar structure. In various embodiments, during the provision of particular set of content within a content block, the user interface may include control elements for accessing other content blocks from within a particular day (i.e., to access such content ahead of schedule), in addition to control elements for delaying the modification of the user interface to provide access to subsequent content blocks according to the schedule. In other embodiments, the system may generate a user interface for display according to a particular timing schedule. As such, various embodiments described herein are directed to a specific improved method for displaying and navigating through the generated user interfaces (i.e., via the progression through the set of content blocks within a day), particularly when the generated user interfaces include a structure defined by the content blocks, including timing based display requirements for each of the content blocks.

Other problems can be addressed by various user interface features described herein. For instance, a user interface configuration system can include a plurality of time-defined content blocks with functionalities that facilitate the automation of the generation of the user interfaces, and automated progression of the user interfaces based on a defined timing schedule. Thus, the structure and associated functionality of the interface features described herein can provide improvements in the field of user interface generation, input, presentation, and modification.

### Example Computing Environment

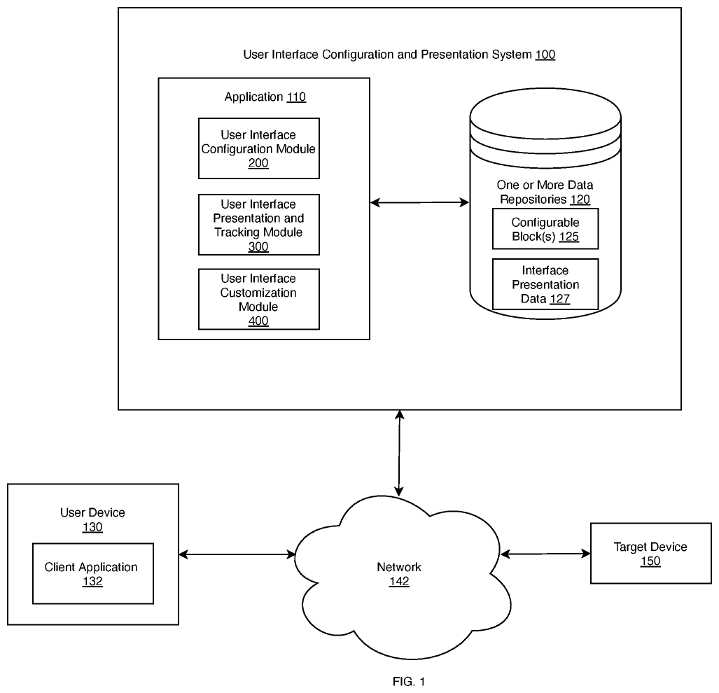

FIG. 1 depicts an example of a computing environment that can be used for configuring, generating, and presenting graphical user interfaces for display (e.g., over a computer network) on a computing device. For example, a user interface configuration and presentation system 100 may be configured to generate and configure a graphical user interface for display on a user device. In various embodiments, the graphical user interface may include a particular structure including content blocks that make up a defined calendar of events for a particular user. In various embodiments, the calendar of events may define a plurality of content blocks that include respective pieces of content (e.g., sets of content) for each of the plurality of content blocks, with each of the plurality of content blocks making up a particular block of time within the calendar of events.

FIG. 1 depicts examples of hardware components of a user interface configuration and presentation system 100 according to various embodiments. In some embodiments, the user interface configuration and presentation system 100 may include any computing system on which an application 110 for configuring user interfaces, presenting the user interfaces, and customizing the user interfaces resides. The user interface configuration and presentation system 100 includes a specialized computing system that may be used for configuring user interfaces to include content blocks that correspond to time periods within a defined calendar. In some embodiments, the user interface configuration and presentation system 100 may be configured for reducing cumbersome or time-consuming processes related to navigating to desired content during a particular presentation (i.e., time period thereof) of user interfaces in order to include particular content in the presentation of the user interfaces.

The user interface configuration and presentation system 100 may include various computing components such as an application 110 (e.g., software application). In particular embodiments, the user interface configuration and presentation system 100 may receive user input related to configuring a customized user interface related to generating the customized user interface to include particular content blocks. For example, the user interface configuration and presentation system 100 may receive, via a client application 132 executing on a user device 130, user input related to configuring content blocks for inclusion in a customized user interface. The user input may, for example, indicate particular content for inclusion in a particular content block (e.g., documents, links, access to particular software applications, etc.).

The user interface configuration and presentation system 100 may further communicate (e.g., via a network 142) with a user device 130. In various embodiments, the user device 130 may include any suitable computing device (e.g., a tablet computing device, mobile computing device, desktop computing device, laptop computing device, an interactive flat panel display, etc.) that provides a client application 132 for engaging one or more features of the user interface configuration and presentation system 100. In particular embodiments, the user device 130 may interact, via the network 142 (e.g., public data network, private data network, the internet, etc.), with various target devices 150 for display, sharing, presenting, or otherwise providing one or more graphical user interfaces generated by the user interface configuration and presentation system as described herein.

In various embodiments, the user interface configuration and presentation system 100 may include an interactive touchscreen display device. In particular embodiments, the interactive touchscreen display device may include any suitable interactive touch-screen display device (e.g., such as any suitable Promethean ActivPanel display). In any embodiment described herein, the interactive touchscreen display device comprises: (1) an interactive display device touch surface; and (2) an interactive display device bezel (or other touch capture device such as PCAP technology, etc.) (which may, for example, form a substantially rectangular frame about a perimeter of the interactive display device touch surface). In some embodiments, the interactive touchscreen display device is configured to display data (e.g., video data, image data, etc.). In particular embodiments, the interactive touchscreen display device is configured to receive inputs at an interactive display device touch surface.

In particular embodiments, the user interface configuration and presentation system 100 can include one or more third-party devices such as, for example, one or more servers operating in a distributed manner. The user interface configuration and presentation system 100 can include any computing device or group of computing devices, and/or one or more server devices. The user interface configuration and presentation system 100 may include computing hardware performing different processes for configuring and/or presenting user interfaces on the user device 30. For instance, the user interface configuration and presentation system 100 executes: (1) a user interface configuration module 200 to configure content blocks in a customized user interface; (2) a user interface presentation and tracking module 300 to display content based on one or more content blocks and record data during presentation of content; and (3) a user interface customization module 400 to modify one or more content blocks based on data recorded during presentation of the content.

In other embodiments, the user interface configuration and presentation system 100 includes one or more data repositories 120 that may include, for example, one or more configurable blocks 125 and/or interface presentation data 127. In various embodiments, the one or more configurable blocks 125 include stored content blocks which a user may, for example request to include in a generated user interface. In some embodiments, the stored content blocks 125 include one or more pieces of content and a defined presentation time (e.g., length).

The number of devices depicted in FIG. 1 are provided for illustrative purposes. It should be understood that, in some embodiments, different number of devices may be used. In various embodiments, for example, while certain devices or systems are shown as single devices in FIG. 1, multiple devices may instead be used to implement these devices or systems.

### User Interface Configuration Module

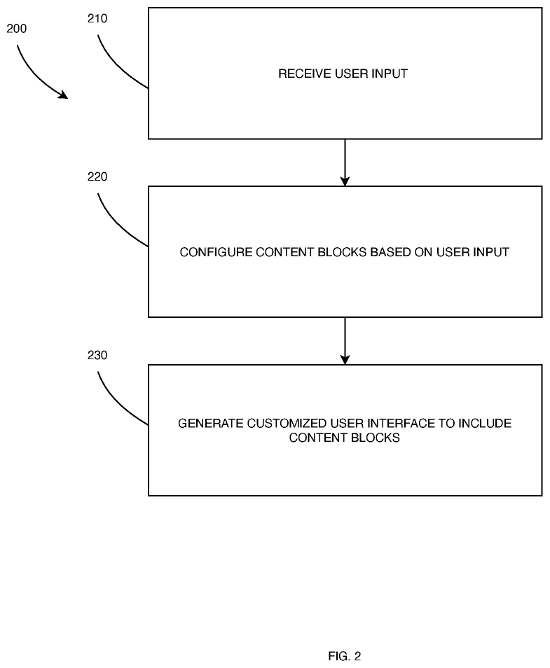

FIG. 2 depicts an example of a process performed by a user interface configuration module 200. This process includes operations that the user interface configuration and presentation system 100 may execute to generate customized user interfaces based on user-defined content blocks. For instance, the flow diagram shown in FIG. 2 may correspond to operations carried out, for example, by computing hardware found in the user interface configuration and presentation system 100, as the computing hardware executes the user interface configuration module 200.

When executing the user interface configuration module 200, the user interface configuration and presentation system 100 may, at operation 210, receive user input. In particular embodiments, the user input may include, for example, input related to particular content (e.g., a content file, such as a video and/or audio file), a link to particular content, etc. In various embodiments, the user input may include input related to one or more computer files to be associated with and/or included in a particular content block. In some aspects, a content block may define a particular set of content for display during a particular lesson or other presentation. In various embodiments, when configuring a user interface, the user interface configuration and presentation system 100 may receive input related to particular content for inclusion in a particular content block. The information related to particular content may include the location of one or more files that should be accessible during the content block, a link to web-based content that should be available, a name of a software application that should be accessible during the content block, one or more documents that should be accessible during the content block, etc. In other embodiments, the user input may include input related to a time constraint for particular content. In various aspects, the system is configured to enable a user to create content blocks by defining attributes of a content block such as name, lesson name, lesson files, length (i.e., time length), etc. In various embodiments, the input comprises selection, via a user interface, of one or more pre-made content blocks (e.g., lessons) for incorporating into a particular day of presentation (e.g., teaching). In other embodiments, the input may comprise a timing constraint for a particular content block, defining a length of time for which a particular content block should run. In still other embodiments, the input may include any input suitable for selecting or configuring particular content that makes up a content block. This may, for example, include an indication of a software application that will be utilized during the content block. In various aspects, the input includes selection, by the user, of a set of content blocks for one or more days of the week. In this way, a user may utilize the user interface configuration and presentation system 100 to configure accessible content during the course of a complete day.

Returning to operation 220, the user interface configuration and presentation system 100 may configure content blocks based on the user input. In various embodiments, the user interface configuration and presentation system 100 may define a plurality of content blocks that correspond to respective time periods within a week and/or day-defined segment of a weekly block schedule of time. For example, the user interface configuration and presentation system 100 may configure content blocks to include a plurality of time segments that make up a day within a particular week. The system may further configure each content block to include the defined content. For example, the system may store one or more copies of each of the pieces of content, one or more links to the content, etc. in order to make the content accessible via a single interface during presentation (i.e., by generating user interfaces during presentation of each content block that are customized based on the content block to include one or more elements or configurable objects for accessing each piece of content within the content block). In various embodiments, the configuring the content blocks may include configuring a particular access order (e.g., default access order) for each piece of content in the set of content that makes up the content block. In other embodiments, the system may integrate an executable within the content block that is configured for launching a particular software application that will be utilized during the block.

At operation 230, the system may generate customized user interface(s) to include the content blocks. In some embodiments, generating the customized user interface(s) comprises generating customized user interface(s) that include a calendar view of one or more days. In some embodiments, the calendar view includes a plurality of the content blocks in a calendar view that provides a block of content for each time block of a plurality of time blocks that define each particular day that makes up a particular week. In particular embodiments, generating the customized calendar view includes generating a user interface that includes a vertical stack of content blocks arranged in time order from the begging of a day to the end of a day. In still other embodiments, generating the user interface includes generating a horizontal stack of content blocks arranged in time order from the begging of a day to the end of a day. In particular aspects, generating the customized calendar view includes generating an adjacent set of content blocks that progress from a first time to a second time, such that each adjacent block has a beginning time that corresponds to an end time of a preceding block. In still other embodiments, the system generates the user interface such that each set of adjacent content blocks that represent a day's set of content are adjacent to an adjacent day's set of content blocks. In this way, the system may generate a calendar view that depicts one or more day's worth of content (i.e., current, past, and future content blocks) for display in a single interface. In particular aspects, from such an interface, a user may access any individual content block according to a time-defined schedule (i.e., by date and time), or the user may access any individual content block on-the-fly (i.e., out of order or at a time other than a time defined by the particular content block). In this way, the system may provide a schedule-defined manner of presenting a set of content blocks in a particular user-defined order, while still enabling the user to break schedule as necessary (e.g., to revisit a set of content from an earlier day in the week, preview a set of content ahead of schedule, delay presentation of a particular set of content, extend presentation of a set of content that is requiring additional time, etc.).

In some aspects, the system may configure each of the plurality of content blocks to launch a presentation element configured to display at least one respective piece of content during the presentation of the respective content block. Launching the presentation element may include, for example, opening and displaying a first piece of content defined by the content block, generating user-selectable objects for accessing (e.g., launching, opening, etc.) one or more additional pieces of content that make up the content block, etc. In some aspects, the system is configured to automatically progress through a set of content within a content block (e.g., as defined by user-input prior to presentation or defined by time constraint data for the block). In other embodiments, the system is configured to make the set of content available on the user interface for access during the presentation of a particular content block.

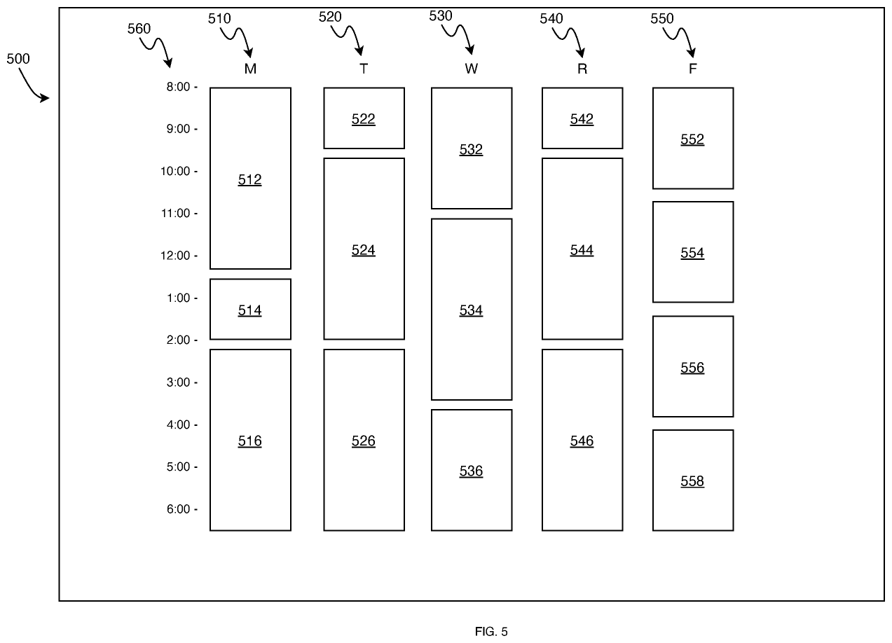

For example, FIG. 5 depicts a customized user interface 500 that includes various content blocks that make up each of the five days of the week. As may be understood in FIG. 5, the system may generate the user interface to include a column of content blocks corresponding to a respective day of the week, each of the content blocks being configured to access the content in the content block during a corresponding time on a corresponding day. In other embodiments, the system may generate the user interface to include a row of content blocks that define a particular day. In various embodiments, each of the content blocks is selectable by a user. In other embodiments, the system may automatically access content from a particular content blocks during a day and time that corresponds to a time period defined by the content block data (e.g., metadata).

As may be further understood from FIG. 5, the user interface 500 includes respective columns 510, 520, 530, 540, 550 that correspond to each weekday of a week. In other embodiments, the user interface 500 may include any other set of days (i.e., day's worth of content blocks) arranged such that each day's worth of content blocks is arranged adjacent to one another, while the set of content blocks for a particular day is arranged adjacent the set of content blocks for an adjacent day. In this way, the user interface 500 defines a calendar structure that includes at least a portion of one or more days of the week (i.e., Monday, Tuesday, Wednesday, Thursday, Friday). This structure is specifically selected as it is easily identified by users. The structure further enables a user to access each individual piece of content (e.g., 512, 534, etc.) in a set of content defined by a content block during presentation of that content block (e.g., regardless of where each individual piece of content may be accessed). The calendar structure further includes a time range 560 that defines a beginning and end time of each content block that makes up a set of content for any given day of the week. For example, in the set of content blocks on Tuesday 520: content block 522 begins at 8:00 AM and ends at 9:30 AM; content block 524 begins at 9:30 AM and ends at 2:00 PM; and content block 526 begins at 2:00 PM and ends at 6:30 PM. As may be understood by one skilled in the art, when generating the customized calendar structure for the week, the system may be configured to automatically provide access to a particular content block during the time and day of the week defined by that content block. For example, at 11:00 AM on Tuesday, the system may be configured to, by default, provide access to the content that makes up content block 524.

As shown in FIG. 5, the calendar configuration of the user interface 500 comprises a set of content blocks 512, 514, 516 that make up a first day (Monday 510), a set of content blocks 522, 524, 526 that make up a second day (Tuesday 520), a set of content blocks 532, 534 536 that make up a third day (Wednesday 530), a set of content blocks 542, 544, 546 that make up a fourth day (Thursday 540), and a set of content blocks 552, 554, 556, 558 that make up a fifth day (Friday 550). As shown in this figure, each set of content blocks for the respective day is configured and sized based on a corresponding time frame defined by each block. For example, each individual content block for each day has a start time and end time that corresponds to a timeline 560 for each day's set of content blocks (e.g., content block 532 on Wednesday 530 begins at 8:00 AM and ends at 11:00 AM). As may be understood based on the discussion herein, the user interface 500 shown in FIG. 5 is customized based on each content block that makes up the set of content blocks for each day in the defined week (i.e., included in the calendar structure defined by the set of blocks).

As described herein, certain embodiments provide improvements in graphics processing by automatically applying various rules of a particular type, such as constraints and/or timing with respect to particular content blocks, to control the manner in which computing devices dynamically generate user interfaces for presenting media content. For example, these embodiments automatically compute and configure an arrangement of user interfaces for accessing particular portions of content (i.e., sets of content) in a centralized location. Examples of these configuration parameters could include, for example, user interface timing constraints, display constraints, etc. Furthermore, using timing data and content linking defined by a set of rules to generate the user interfaces allows for the dynamic generation of content with a greater degree of automation than provided by conventional solutions. This process reduces or eliminates the need to rely on user inputs (e.g., navigating to desired content, opening the content, displaying the content according to a particular schedule, launching a software program required to access the content, etc.) to manually access particular content and display the content according to a defined schedule.

The automated application of these rules are facilitated by and specifically improve user interface generation. By contrast, conventional techniques for generating user interfaces for displaying content require subjective determinations applied to imprecise manual operations, such as manually checking for a location from which the content is accessible, manually adjusting a layout or content combinations to maintain a presentation schedule for the content, manually navigating to different software applications and sources of content to access and display particular content at a particular time, etc. Thus, embodiments described herein improve computer-implemented processes that are unique to generating user interfaces, thereby providing a more suitable solution for automating tasks previously performed by humans.

Returning to FIG. 5, in particular embodiments, in response to selection, by a user, of a particular content block (e.g., content block 524 in FIG. 5), the system may modify the user interface such that: (1) at least a portion of the content blocks are removed and/or obscured in the user interface; (2) at least one day's worth of content blocks remains on the user interface (e.g., or a portion of the day's content blocks); and (3) one or more pieces of content defined by (e.g., associated with) the selected time block are presented on (e.g., or available via) the user interface.

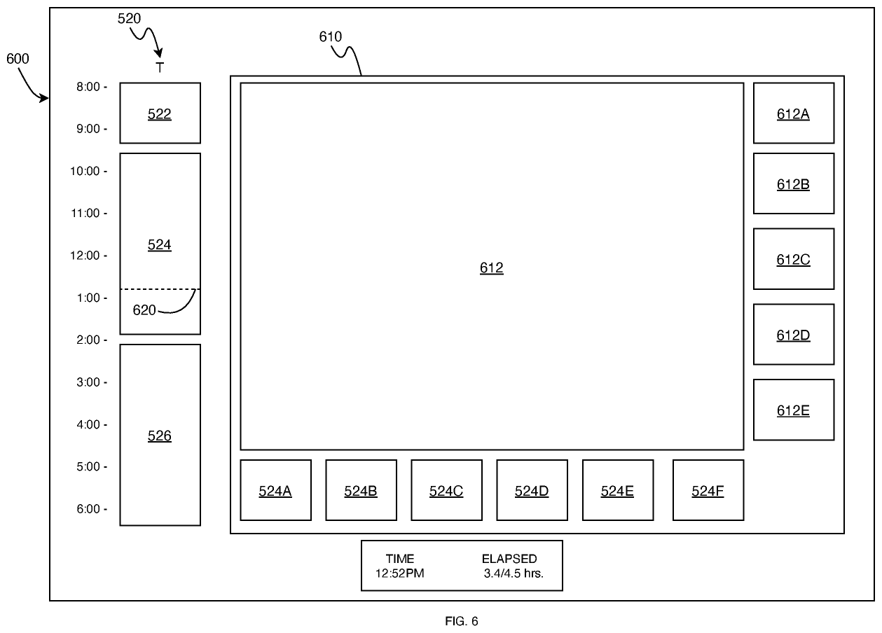

FIG. 6, for example, depicts an exemplary user interface 600 for displaying content from a particular content block 524 (e.g., during a particular day). As shown in this figure, the calendar column for the day of the week (e.g., Tuesday 520) is included adjacent a presentation area 610. This calendar column 520 depicts the content blocks 522, 524, 526 for the day, as well as a progress indicator 620 through the content blocks based on the current time. The content block display also includes access to various pieces of content for presenting in the presentation area. In some aspects, at least some of the accessible content may include content that persists across content blocks. This content may include, for example, content related to one or more breaks; applications for tracking student attendance, points, and/or participation; user-selectable buttons for pausing a lesson; etc. In this way, a teacher or presenter may have access to a toolbox of content (e.g., applications, etc.) during any particular content block presentation.

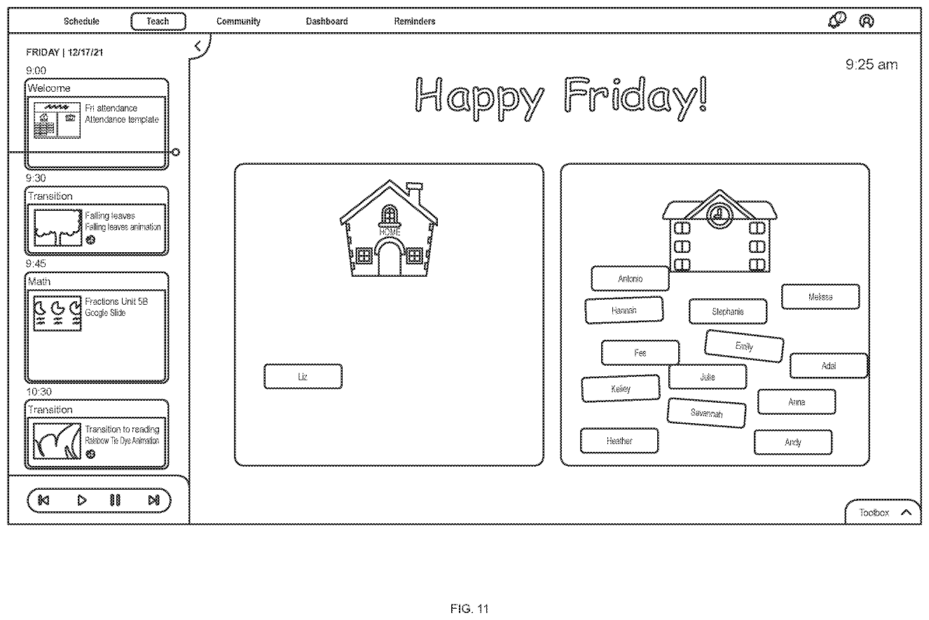

As may be understood from FIG. 6, a user may select any content 524A-F that is included in the content block for display or presentation (e.g., including multiple pieces of content simultaneously). As may be understood in light of the present disclosure, each piece of content may be directly accessible via the single user interface, regardless of a source of the content. In some embodiments, the system may be configured to automatically progress through the content blocks according to the timing data. In some embodiments, the system may enable a user to at least temporarily pause the progression. In some embodiments, the system may enable a user to insert one or more transition blocks between content blocks (see e.g., FIG. 11).

In particular embodiments, in response to selection, by the user of a particular piece of available content (e.g., 524C) during the content block 524, the system is configured to modify the user interface by launching the piece of content 524C and displaying the piece of content 524C within the presentation area 610 (e.g., in window 612 or other presentation element). In particular embodiments, launching the piece of content 524C may include: (1) launching a particular software application (e.g., attendance application, calculator, word processor, annotation program, etc.) for use within the presentation area 610; (2) launching a particular software application required for viewing the piece of content 524C (e.g., word processor, presentation software, video viewing software, image viewing software, etc.); (3) opening a particular document that corresponds to the piece of content 524C (e.g., text document, slide presentation, image, video file, etc.); (4) accessing a link that corresponds to the piece of content 524C in a web browser application; (5) etc. In various embodiments, each piece of content 524A-F within a content block 524 may include a plurality of sub-content 612A-E. This may include, for example, individual slides that make up a slide presentation, pages in a text document, etc. In this way, a user may progress through different components of an individual piece of content (e.g., 524C) by selecting individual portions of the content 612A-E for display on the user interface display portion 612.

In particular embodiments, by generating an interface based on a calendar configuration, the system enables the user interfaces to progress between content blocks automatically based on timing constraint data for each block. In this way, the system may further provide centralized access to content 524A-F for a particular content block 524 (e.g., lesson) at the correct time as defined by the content block time constraints. For example, the system is configured to generate a set of content blocks 522, 524, 526 for a particular day, with each content block having a respective associated timeframe for the day. When generating a user interface for presenting the set of content blocks for the particular day, the system is configured to provide a visual representation 620 of the day's progression through the set of content blocks, while providing access to each piece of content that makes up a particular content block during the time that corresponds to the particular content block's time of day. As may be understood from this disclosure, each particular user interface generated for a particular set of content blocks during a particular time period (e.g., day, week, month, morning, session, lecture, etc.) may be completely customized based on, for example: (1) the content that makes up each content block; (2) timing constraints applied to each content block; (3) user input during presentation of a particular content block; (4) etc. In this way, the implementation of these specifically customized user interfaces specifically improve user interface generation and display.

In some embodiments, the system is configured to automatically close all open content (e.g., any open files, documents, software applications, etc.) when the system advances to the next content block. This may, for example, free up user interface space and computer processing ability (e.g., memory) for use by content included in the subsequent content block.

### User Interface Presentation and Tracking Module

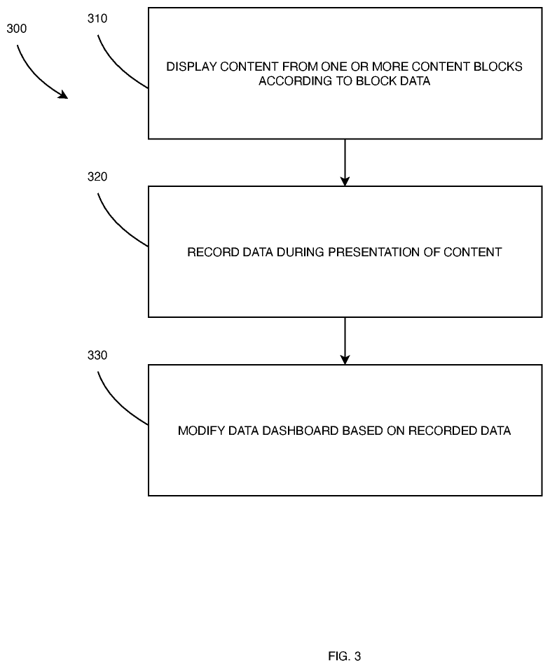

FIG. 3 depicts an example of a process performed by a user interface presentation and tracking module 300. This process includes operations that the user interface configuration and presentation system 100 may execute to display content from various content blocks according to a block schedule. For instance, the flow diagram shown in FIG. 3 may correspond to operations carried out, for example, by computing hardware found in the user interface configuration and presentation system 100, as the computing hardware executes the user interface presentation and tracking module 300.

When executing the user interface presentation and tracking module 300, the system begins, at operations 310 by displaying content from a particular content block according to block data. For example, the system may generate and provide a user interface that includes access to each piece of content linked to the particular block (see e.g., FIG. 6). This may include, as seen in FIG. 6 for example, one or more pieces of multimedia, one or more links, one or more presentations, written content, one or more pictures, etc. In various embodiments, the system may generate user-selectable objects 524A-F for each piece of content associated with a particular content block 524 (e.g., such that a user can selectively open any particular piece of content defined by the block). When displaying the content from the particular content block, the system may modify an initial calendar interface to remove at least some of the content blocks from inclusion in the user interface (e.g., by removing the content blocks associated with days other than a current day (e.g., the day associated with the selected content block). For example, as may be understood from FIGS. 5 and 6, the system may generate a calendar view of an entire week 500 that includes a depiction of a set of days 510, 520, 530, 540, 550 and corresponding content blocks for each portion of each day. For a particular day, a user may select the desired day for presenting (e.g., 520). In response to the selection, the system may generate a second interface that modifies a position of the selected day's set of content blocks 520 (e.g., by moving the set of content blocks 520 for that day adjacent a side portion of the user interface as shown in FIG. 6 and removing, obscuring, repositioning, or otherwise hiding (e.g., to make room on the user interface to display the individual content 612 within the desired block as well as selectable objects for accessing addition content 524A-F that makes up the block) the remaining content blocks 510, 530, 540, 550 that make up the calendar view within FIG. 5. The system may, for example, obscure the other content blocks, remove the content blocks, etc. In various embodiments, the system may be configured to generate a presentation area 610 that is configured to display the selected content 612 from the content block 524. In some embodiments, the system may generate the presentation area adjacent a column of content blocks 520 that corresponds to the current day of the week (e.g., including the currently selected content block 524).

FIG. 6 depicts an exemplary user interface for displaying content from a particular content block. As shown in this figure, the calendar column 520 for the day of the week is included adjacent a presentation area 610. This calendar column 520 depicts the content blocks 522, 524, 526 for the day, as well as progress 620 through the content blocks based on the current time. As may be understood in light of this disclosure, a particular content block 524 may include a particular set of content 524A-F that corresponds to content that may be required for use in a particular lesson. For example, a math lesson may require access to a calculator application, a blackboard application, and a set of slides. By providing a single interface that includes respective selectable objects (e.g., 524A-C) for accessing these different pieces of content during the presentation of the math lesson, the system provides improved user interfaces for accessing the separate content from a single user interface (e.g., even when a particular piece of content or pieces of content is/are in use). For example, the calculator application may be a web-based software application, the blackboard application may be installed locally on the computing device that is displaying the user interface, and the slide presentation may be stored on a cloud-based file system. By providing access to each separate piece of content on a single interface at a specific time defined by user-provided time constraints (i.e., during the math lesson), the system reduce cumbersome, time-consuming processes for navigating to different pieces of content stored on, or otherwise accessible from different locations that requires the use of arbitrary commands to access (e.g., copy pasting links from different computer storage locations, navigating to a particular web page that includes the desired content, finding and navigating to a folder on a computing device on which the content is stored, etc.).

The content block display also includes access to various pieces of content for presenting in the presentation area. In some aspects, at least some of the accessible content may include content that persists across content blocks. This content may include, for example, content related to one or more breaks; applications for tracking student attendance, points, and/or participation; user-selectable buttons for pausing a lesson; etc. In this way, a teacher or presenter may have access to a toolbox of content (e.g., applications, etc.) during any particular content block presentation. As such, the set of content 524A-F available during a particular content block 524 may include specific content (e.g., 524A-C) defined by the content block 524 that is custom to the content block, as well as persistent content (e.g., 524D-F) that persists across all content blocks 522, 524, 526, etc. As may be understood from FIG. 6, a user may select any content that is included in the content block for display or presentation (e.g., including multiple pieces of content simultaneously) in a display area 612. As may be understood in light of the present disclosure, each piece of content may be directly accessible via the single user interface, regardless of a source of the content. In some embodiments, the system may be configured to automatically progress through the content blocks according to the timing data. In some embodiments, the system may enable a user to at least temporarily pause the progression. In some embodiments, the system may enable a user to insert one or more transition blocks between content blocks (see e.g., FIG. 11).

At operation 320, the system may be configured to record data during presentation of the content. The system may, for example, record data related to: (1) an amount of time during the content block during which each respective particular piece of content in the block is selected for display; (2) an amount of time that elapses during display of the content block; (3) a number of interruptions recorded during the content block; (4) a number of points awarded to students or viewers during the content block; etc.

In other embodiments, the system may be configured to record user inputs during presentation of the content. These user inputs may include input regarding selection of particular selectable objects during a particular lesson, an indication of unused content within a particular block, etc.

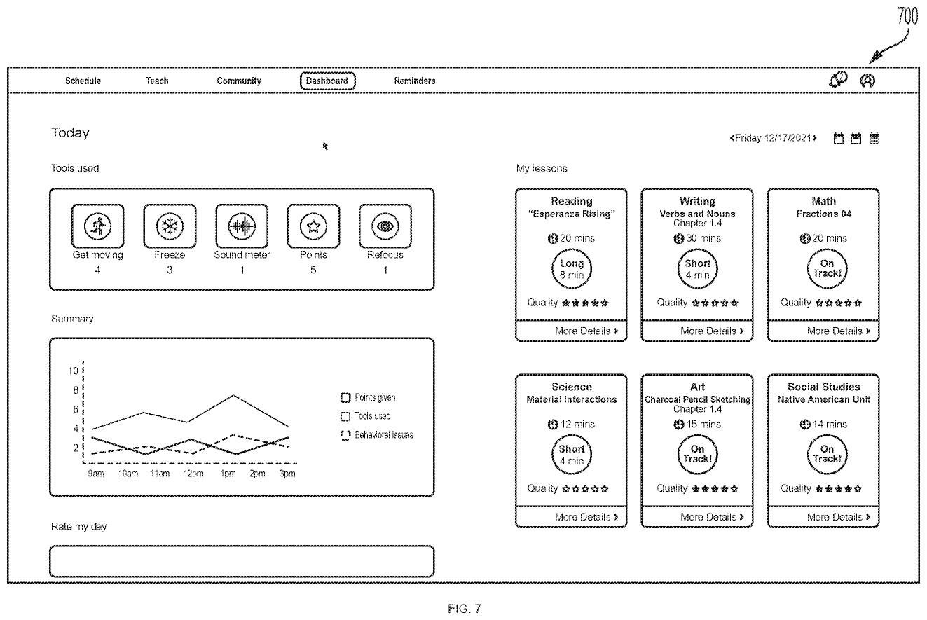

At operation 330, the system may generate and/or modify a data dashboard based on the data recorded during the presentation. FIG. 7 depicts an exemplary dashboard 700 that indicates content block (e.g., lesson) timing data, a number of times certain toolbox items were selected on the user interface during a particular content block, etc. As may be understood from this figure, the system may be configured to generate a customized interface that includes recorded data over a day's worth of content blocks. For example, the dashboard may include a summary of each content block (e.g., lesson such as reading, writing, math, science, art, social studies, etc.) that includes time constraint data for each block (i.e., a schedule length of time of the content block) as well as actual timing data (i.e., whether the scheduled timing was exceeded, shortened, etc.). The dashboard may further include a summary of a number of tools (i.e., persistent content types such as freezes, points awarded, etc. throughout the day. In particular embodiments, the system is configured to record, for each content block in a set of content blocks, usage data for each content block in order to generate the customized dashboard.

### User Interface Customization Module

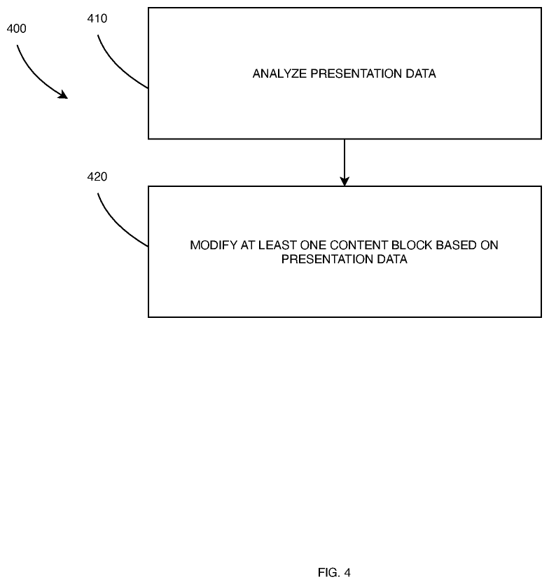

FIG. 4 depicts an example of a process performed by a user interface customization module 400. This process includes operations that the user interface configuration and presentation system 100 may execute to modify content block(s) based on data derived from a presentation of block content. For instance, the flow diagram shown in FIG. 4 may correspond to operations carried out, for example, by computing hardware found in the user interface configuration and presentation system 100, as the computing hardware executes the user interface customization module 400.

When executing the user interface customization module 400, the system may, at operation 410, analyze the presentation data. In some embodiments, the presentation data may include data collected in the context of the user interface presentation and tracking module 300 discussed above. In particular embodiments, the system may analyze the data to determine whether to modify one or more content blocks (e.g., one or more content block definitions). For example, in response to determining that a particular piece of content was not accessed during presentation of the content block, the system may be configured to modify the content block to remove the particular piece of content, generate a user interface that includes a selectable element for removing the particular piece of content, etc. In this way, the modified content block may be made available for other users to select and use in future presentations without being encumbered by selectable objects that aren't necessary to the presentation of the content within the content block. In this way, the system may generate and provide user interfaces that provide an improved user experience, without cluttering the interface with unnecessary objects and other additions that may distract the user.

In other embodiments, the system may determine, in response to a total time spent presenting the content block, whether to modify a timing component of the content block. For example, in response to determining that the content block was presented for 15 minutes longer than the predefined time, the system may modify the content block to increase the predefined time. In this way, when future users present the content block, the content block may include additional time for presenting the content by default.

The system may then, at operation 420, modify at least one content block based on the presentation data. In some embodiments, the system is configured to analyze presentation data across a plurality of users (e.g., a plurality of users that utilize the same content blocks as part of a lesson), and modify the content block based on the overall presentation data.

In various embodiments, the system may process the presentation data (e.g., for each of a plurality of users) using a rules-based model, a machine-learning model, or both to modify one or more content blocks. For example, the rules-based model, machine learning model, or combination of both may be configured to process the presentation in determining whether to modify a particular content block, and how to modify the block. For example, the rules-based model, machine learning model, or combination of both may be configured to customize the at least one content block by identifying one or more discrepancies between the content contained therein and one or more actual presentations. The one or more discrepancies may include, for example, non-use of particular content, a timing exceeding or falling short of the time constraint, etc.

For example, according to particular embodiments, the system may involve using a rules-based model in determining and applying a customization. The rules-based model may comprise a set of rules that determines whether to customize a particular content block, and what type of customization to apply. For example, the set of rules may define one or more rules for modifying a time constraint for a particular content block based on a length of time that the content block was presented. For example, the set of rules may define an amount to increase or decrease the time constraint based on an amount of time that the actual presentation time exceeds or falls short of the time constrain. In other embodiments, the set of rules may define one or more rules for removing particular content from the content block in response to determining that particular content was not presented during the content block. Accordingly, an entity may maintain the set of rules in some type of data storage, such as a database from which the system can access the set of rules for applying customizations.

According to other embodiments, the system may utilize a machine learning model in applying customizations to particular content blocks. Here, the machine learning model may be trained using historical data on presentation data, user acceptance/rejection of prior customizations, etc. For instance, according to some embodiments, the machine learning model may customize a time constraint for a content block based on a prediction as to a likelihood that future users will exceed a time constraint for the content block made based on prior users' presentation times with the particular block. Accordingly, the machine learning model may be configured using a variety of different types of supervised or unsupervised trained models such as, for example, support vector machine, naive Bayes, decision tree, neural network, and/or the like.

In some embodiments, in response to determining that a particular content block has exceeded or fallen short of a predefined time constraint, the system may be configured to modify a time constraint for one or more subsequent content blocks in a set of content blocks (e.g., a set of content blocks that make up a particular day). For example, in response to determining that a content block went over an allotted time by a particular number of minutes, the system may be configured to decrease one or more remaining content blocks during that day by at least that particular number of minutes. For example, in various embodiments, the system may be configured to reduce a length of each remaining content block of the day by a respective length of time such that the total reduction is equal to the number of minutes by which the current content block exceeded its allotted time (e.g., thereby distributing the lost time equally among the remaining content blocks for the day). In other embodiments, the system may be configured to modify a time constraint for the content block that immediately follows (i.e., by reducing a length of time of the subsequent content block by an amount of time that correlates to the amount of time by which the initial content block was extended).

### Example Technical Platforms

Embodiments of the present disclosure may be implemented in various ways, including as computer program products that include articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

According to various embodiments, a non-volatile computer-readable storage medium may include a floppy disk, flexible disk, hard disk, solid-state storage (SSS) (e.g., a solid-state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

According to various embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where various embodiments are described to use a computer-readable storage medium, other types of computer-readable storage media may be substituted for or used in addition to the computer-readable storage media described above.

Various embodiments of the present disclosure may also be implemented as methods, apparatuses, systems, computing devices, computing entities, and/or the like. As such, various embodiments of the present disclosure may take the form of a data structure, apparatus, system, computing device, computing entity, and/or the like executing instructions stored on a computer-readable storage medium to perform certain steps or operations. Thus, various embodiments of the present disclosure also may take the form of entirely hardware, entirely computer program product, and/or a combination of computer program product and hardware performing certain steps or operations.

Various embodiments of the present disclosure are described below with reference to block diagrams and flowchart illustrations. Thus, each block of the block diagrams and flowchart illustrations may be implemented in the form of a computer program product, an entirely hardware aspect, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some examples of embodiments, retrieval, loading, and/or execution may be performed in parallel such that multiple instructions are retrieved, loaded, and/or executed together. Thus, such embodiments can produce specially configured machines performing the steps or operations specified in the block diagrams and flowchart illustrations. Accordingly, the block diagrams and flowchart illustrations support various combinations of embodiments for performing the specified instructions, operations, or steps.

### Example System Architecture

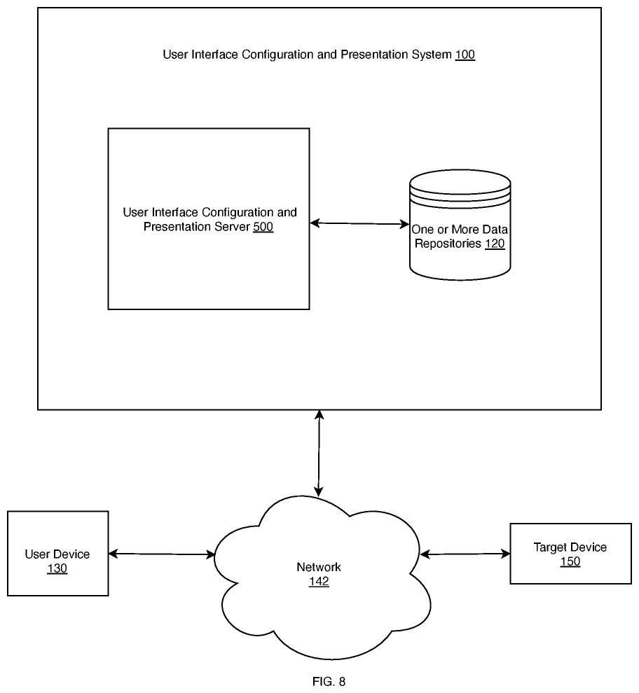

FIG. 8 depicts an example of a computing environment that can be that can be used for configuring, generating, and presenting graphical user interfaces for display (e.g., over a computing network) on a computing device. Components of the system architecture are configured according to various embodiments generate and customize user interfaces on a user interface configuration and presentation system 100.

As may be understood from FIG. 8, the system architecture according to various embodiments may include a user interface configuration and presentation system 100 that includes a user interface configuration and presentation server 500 and one or more data repositories 120. Although the user interface configuration and presentation server 500, user interface configuration and presentation system 100, and one or more data repositories 120 are shown as separate components, according to other embodiments, these components may include a single server and/or repository, servers and/or repositories, one or more cloud-based servers and/or repositories, or any other suitable configuration.

The user device 130, user interface configuration and presentation server 500, target device 150, and/or other components may communicate with, access, and/or the like with each other over one or more networks, such as via a network 142. According to particular embodiments, the user interface configuration and presentation server 500, and/or user device 130, may provide one or more interfaces that allow the user interface configuration and presentation server 500, user interface configuration and presentation system 100, user device 130, target device 150, and one or more data repositories 120 to communicate with each other such as one or more suitable application programming interfaces (APIs), direct connections, and/or the like.

### Example Computing Hardware

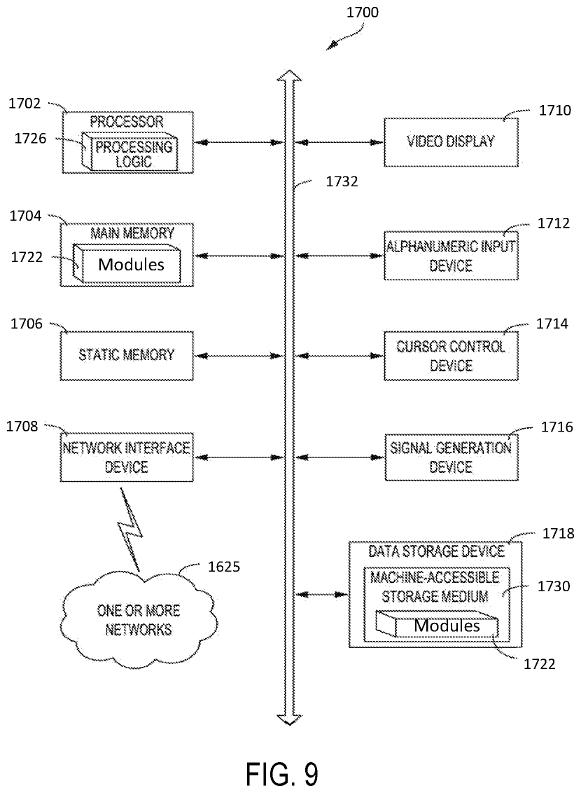

FIG. 9 illustrates a diagrammatic representation of a computing hardware device 1700 that may be used in accordance with various embodiments of the disclosure. For example, the hardware device 1700 may be any computing hardware described herein. According to particular embodiments, the hardware device 1700 may be connected (e.g., networked) to one or more other computing entities, storage devices, and/or the like via one or more networks such as, for example, a LAN, an intranet, an extranet, and/or the Internet. As noted above, the hardware device 1700 may operate in the capacity of a server and/or a client device in a client-server network environment, or as a peer computing device in a peer-to-peer (or distributed) network environment. According to various embodiments, the hardware device 1700 may be a personal computer (PC), a tablet PC, a set-top box (STB), a Personal Digital Assistant (PDA), a mobile device (smartphone), a web appliance, a server, a network router, a switch or bridge, or any other device capable of executing a set of instructions (sequential or otherwise) that specify actions to be taken by that device. Further, while only a single hardware device 1700 is illustrated, the term “hardware device,” “computing hardware,” and/or the like shall also be taken to include any collection of computing entities that individually or jointly execute a set (or multiple sets) of instructions to perform any one or more of the methodologies discussed herein.

A hardware device 1700 includes a processor 1702, a main memory 1704 (e.g., read-only memory (ROM), flash memory, dynamic random-access memory (DRAM) such as synchronous DRAM (SDRAM), Rambus DRAM (RDRAM), and/or the like), a static memory 1706 (e.g., flash memory, static random-access memory (SRAM), and/or the like), and a data storage device 618, that communicate with each other via a bus 1732.

The processor 1702 may represent one or more general-purpose processing devices such as a microprocessor, a central processing unit, and/or the like. According to some embodiments, the processor 1702 may be a complex instruction set computing (CISC) microprocessor, reduced instruction set computing (RISC) microprocessor, very long instruction word (VLIW) microprocessor, a processor implementing other instruction sets, processors implementing a combination of instruction sets, and/or the like. According to some embodiments, the processor 602 may be one or more special-purpose processing devices such as an application specific integrated circuit (ASIC), a field programmable gate array (FPGA), a digital signal processor (DSP), network processor, and/or the like. The processor 602 can execute processing logic 626 for performing various operations and/or steps described herein.

The hardware device 1700 may further include a network interface device 1708, as well as a video display unit 1710 (e.g., a liquid crystal display (LCD), a cathode ray tube (CRT), and/or the like), an alphanumeric input device 1712 (e.g., a keyboard), a cursor control device 614 (e.g., a mouse, a trackpad), and/or a signal generation device 1716 (e.g., a speaker). The hardware device 1700 may further include a data storage device 1718. The data storage device 1718 may include a non-transitory computer-readable storage medium 1730 (also known as a non-transitory computer-readable storage medium or a non-transitory computer-readable medium) on which is stored one or more modules 1722 (e.g., sets of software instructions) embodying any one or more of the methodologies or functions described herein. The one or more modules 1722 may also reside, completely or at least partially, within main memory 1704 and/or within the processor 1702 during execution thereof by the hardware device 1700—main memory 1704 and processor 1702 also constituting computer-accessible storage media. The one or more modules 1722 may further be transmitted or received over a network 142 via the network interface device 1708.

While the computer-readable storage medium 1730 is shown to be a single medium, the terms “computer-readable storage medium” and “machine-accessible storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding, and/or carrying a set of instructions for execution by the hardware device 1700 and that causes the hardware device 1700 to perform any one or more of the methodologies of the present disclosure. The term “computer-readable storage medium” should accordingly be understood to include, but not be limited to, solid-state memories, optical and magnetic media, and/or the like.

### System Operation

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, steps, structural devices, acts, or modules. These states, operations, steps, structural devices, acts, and modules may be implemented in software, in firmware, in special purpose digital logic, and any combination thereof. Greater or fewer operations may be performed than shown in the figures and described herein. These operations also may be performed in a different order than those described herein.

### User Experience

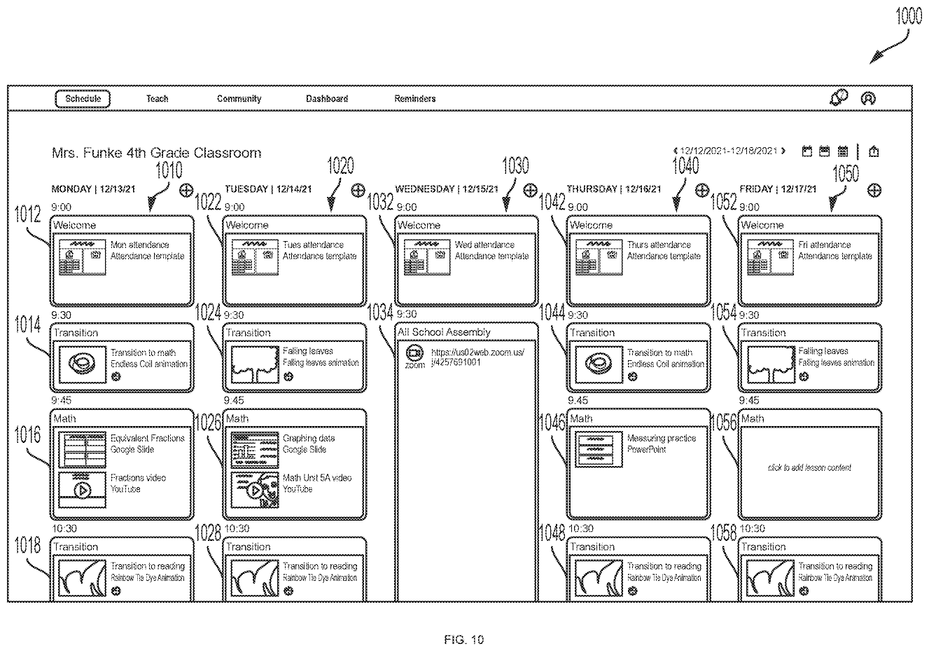

FIGS. 10-13 depict user interfaces that the system may generate and a user may encounter displayed on a computing device according to particular embodiments.

For example, FIG. 10 depicts a customized user interface 1000 that includes various content blocks 1010, 1020, 1030, 1040, 1050 that make up each of the five days of the week. As may be understood in FIG. 10, the system may generate the user interface to include a column of content blocks corresponding to a respective day of the week, each of the content blocks being configured to access the content in the content block during a corresponding time on a corresponding day. In other embodiments, the system may generate the user interface to include a row of content blocks that define a particular day. In various embodiments, each of the content blocks is selectable by a user. In other embodiments, the system may automatically access content from a particular content blocks during a day and time that corresponds to a time period defined by the content block data (e.g., metadata). In particular aspects, the user interface 1000 defines a calendar structure that includes at least a portion of one or more days of the week.

As may be further understood from FIG. 10, the user interface 51000 includes respective columns 1010, 1020, 1030, 1040, 1050 that correspond to each weekday of a week. In other embodiments, the user interface 1000 may include any other set of days (i.e., day's worth of content blocks) arranged such that each day's worth of content blocks is arranged adjacent to one another, while the set of content blocks for a particular day is arranged adjacent the set of content blocks for an adjacent day. In this way, the user interface 1000 defines a calendar structure that includes at least a portion of one or more days of the week (i.e., Monday, Tuesday, Wednesday, Thursday, Friday). This structure is specifically selected as it is easily identified by users. The structure further enables a user to access each individual piece of content (e.g., 1012, 1034, etc.) in a set of content defined by a content block during presentation of that content block (e.g., regardless of where each individual piece of content may be accessed). The calendar structure further includes time stamps that defines a beginning and end time of each content block that makes up a set of content for any given day of the week. For example, in the set of content blocks on Tuesday 1020: content block 1022 (Welcome) begins at 9:00 AM and ends at 9:30 AM; content block 1024 (Transition) begins at 9:30 AM and ends at 9:45 AM; content block 1026 (Math) begins at 9:45 AM and ends at 10:30 AM; and content block 1028 (Transition) begins at 10:30 AM. As may be understood by one skilled in the art, when generating the customized calendar structure for the week, the system may be configured to automatically provide access to a particular content block during the time and day of the week defined by that content block (i.e., the current time and date). For example, at 10:00 AM on Tuesday, the system may be configured to, by default, provide access to the content that makes up content block 1026 (Math).

As may be understood from FIG. 10, each individual content block may include a preview of particular content (i.e., one or more pieces of content) that are available during the content block. For example, content block 101 (Math) on Monday 1010 includes at least a Google slide show and a link to a YouTube video. In this way, a user may preview what content may be available in a current or future content block.

As shown in FIG. 10, the calendar configuration of the user interface 1000 comprises a set of content blocks 1012, 1014, 1016, 1018 that make up a first day (Monday 1010), a set of content blocks 1022, 1024, 1026, 1028 that make up a second day (Tuesday 1020), a set of content blocks 1032, 1034 that make up a third day (Wednesday 1030), a set of content blocks 1042, 1044, 1046, 1048 that make up a fourth day (Thursday 1040), and a set of content blocks 1052, 1054, 1056, 1058 that make up a fifth day (Friday 1050). As shown in this figure, each set of content blocks for the respective day is configured and sized based on a corresponding time frame defined by each block. For example, each individual content block for each day has a start time and end time that corresponds to a timeline for each day's set of content blocks. Shorter content blocks are sized differently from longer content blocks, and the size of each block corresponds to its total time. As may be understood based on the discussion herein, the user interface 1000 shown in FIG. 10 is customized based on each content block that makes up the set of content blocks for each day in the defined week (i.e., included in the calendar structure defined by the set of blocks).

As described herein, in response to selection, by a user, of a particular content block (e.g., content block 1052 in FIG. 10), the system may modify the user interface such that: (1) at least a portion of the content blocks are removed and/or obscured in the user interface; (2) at least one day's worth of content blocks remains on the user interface (e.g., or a portion of the day's content blocks); and (3) one or more pieces of content defined by (e.g., associated with) the selected time block are presented on (e.g., or available via) the user interface. In other embodiments, when a user begins or activates a presentation interface, the system automatically accesses and launches a particular content block based on a current date and time and the set of content blocks defined by the calendar structure (e.g., at 9:00 AM on Friday, the system may automatically access content block 1052).

FIG. 11 depicts an exemplary interface displaying content block 1052 from FIG. 10. As may be understood from this figure, the set of content blocks (e.g., representing a portion of the day's scheduled set of content blocks) has been repositioned adjacent a side portion of the user interface) and a piece of content (e.g., an attendance application) from the content block is displayed in a display area.

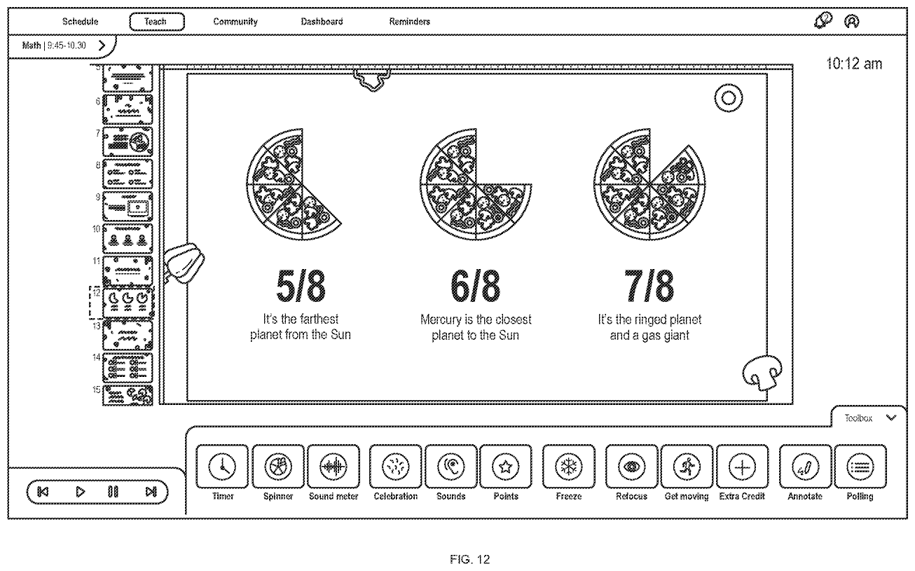

Turning to FIG. 12 another exemplary display is shown. Here, a particular piece of content is displayed in a display area, along with a view of additional portions of a slide presentation. In this figure, the set of content blocks for the remainder of the day have been obscured to provide additional presentation space. This figure also includes a user-accessible toolbox that includes persistent content that a user may access during any content block (e.g., a timer, spinner, sound meter, celebration effect, sounds, point tracking application, selectable freeze function to pause a time of the content block, available applications to refocus viewers, etc.).

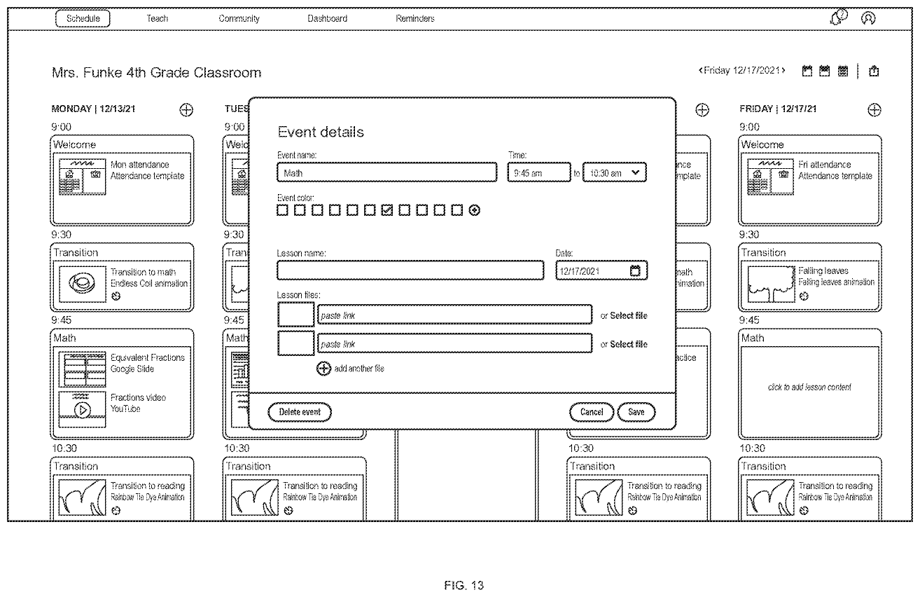

FIG. 13 depicts a user interface via which a user may generate a new content block for inclusion in a set of content blocks (e.g., for a particular day). As may be understood from this figure, user may input block information such as a name, provide definitions such as a time period (e.g., start time and end time or length of time), a date, and link or add particular content for inclusion in the content block (e.g., lesson, presentation, etc.). In various other embodiments, uses may select from pre-made content blocks (e.g., content blocks that the user or other users have previously created), share content blocks that they have made, etc.

### CONCLUSION

Many modifications and other embodiments of the invention will come to mind to one skilled in the art to which this invention pertains having the benefit of the teachings presented in the foregoing descriptions and the associated drawings. While this specification contains many specific embodiment details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Additionally, while some steps may be described as occurring in response to (e.g., or at least partially in response to) particular other steps, it should be understood that, in other embodiments, such steps may occur independent of (e.g., or coincident with) one another. In certain circumstances, multitasking and parallel processing may be advantageous. Moreover, the separation of various system components in the embodiments described above should not be understood as requiring such separation in all embodiments, and it should be understood that the described program components and systems may be generally integrated together in a single software product or packaged into multiple software products.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A method comprising:
receiving, by computing hardware, user-defined content data for each of a plurality of content blocks, the user-defined content data including at least one respective piece of content for each of the plurality of content blocks and a respective time constraint for each of the plurality of content blocks;
generating, by computing hardware, a graphical user interface that includes the plurality of content blocks by arranging the plurality of content blocks according to each respective time constraint such that:
each of the plurality of content blocks is sized according to the respective time constraint; and
the plurality of content blocks are arranged in at least one column, the column corresponding to a day's worth of content blocks;
configuring, by the computing hardware, each of the plurality of content blocks to launch a presentation element configured to display the at least one respective piece of content;
providing, by the computing hardware, the graphical user interface for display on a computing device; and
causing the computing device to automatically progress from a first content block of the plurality of content blocks to a second content block of the plurality of content blocks according to each respective time constraint.

2. The method of claim 1, wherein:
the at least one column comprises at least five columns; and
each of the at least five columns corresponds to a respective day of the week.

3. The method of claim 1, further comprising:
receiving, by the computing hardware, presentation data related to each of the plurality of content blocks during presentation of each of the plurality of content blocks on the computing device; and
modifying, by the computing hardware, at least one of the at least one respective piece of content or the respective time constraint for at least one of the plurality of content blocks based on the presentation data.

4. The method of claim 3, the method comprises modifying the respective time constraint based on the presentation data to increase or decrease the respective time constraint based on a presentation time determined from the presentation data.

5. The method of claim 3, wherein modifying the respective time constraint comprises modifying, on the graphical user interface, a size of the at least one of the plurality of content blocks.

6. The method of claim 1, wherein:
the at least one column comprises a first column and a second column;
the method further comprises:
receiving, via the graphical user interface, selection of a particular content block of the plurality of content blocks;
in response to receiving the selection:
modifying the graphical user interface to include the presentation element;
identifying a column that includes the particular content block;
determining that the particular content block is in the first column; and
in response to determining that the particular content block is in the first column, obscuring the second column from the graphical user interface and positioning the first column adjacent the presentation element.

7. The method of claim 6, wherein obscuring the second column comprises removing the second column from the graphical user interface.

8. A system comprising:
a non-transitory computer-readable medium storing instructions; and
processing hardware communicatively coupled to the non-transitory computer-readable medium, wherein the processing hardware is configured to execute the instructions and thereby perform operations comprising:
receiving user-defined content data for each of a plurality of content blocks, the user-defined content data including at least one respective piece of content for each of the plurality of content blocks and a respective time constraint for each of the plurality of content blocks;
generating a graphical user interface that includes the plurality of content blocks by arranging the plurality of content blocks according to each respective time constraint such that:
each of the plurality of content blocks is sized according to the respective time constraint; and
the plurality of content blocks are arranged linearly;
configuring each of the plurality of content blocks to launch a presentation element configured to display the at least one respective piece of content; and
providing the graphical user interface for display on a computing device.

9. The system of claim 8, wherein:
the plurality of content blocks comprise:
a first content block defining a first piece of content and a second piece of content; and
a second content block defining a third piece of content and a fourth piece of content; and
the operations further comprise:
launching the first content block by:
modifying the graphical user interface to include the presentation element;
modifying the graphical user interface to include a first selectable-object configured to launch the first piece of content via the presentation element; and
modifying the graphical user interface to include a second selectable-object configured to launch the second piece of content via the presentation element.

10. The system of claim 9, wherein the operations further comprise:
receiving, via the graphical user interface, selection of the first selectable-object;
in response to receiving the selection of the first selectable-object, launching the first piece of content and displaying the first piece of content via the presentation element.

11. The system of claim 9, wherein the operations further comprise:
launching the second content block by:
modifying the graphical user interface to remove the first selectable-object;
modifying the graphical user interface to remove the second selectable-object;
modifying the graphical user interface to include a third selectable-object configured to launch the third piece of content via the presentation element; and
modifying the graphical user interface to include a fourth selectable-object configured to launch the fourth piece of content via the presentation element.

12. The system of claim 11, wherein launching the second content block comprises launching the second content block in response to expiration of the respective time constraint for the first content block.

13. The system of claim 11, wherein:
launching the first content block comprises modifying the graphical user interface to include a fifth selectable-object configured to launch the fifth piece of content via the presentation element; and
launching the second content block comprises persisting the fifth selectable-object on the graphical user interface.

14. The system of claim 8, wherein:
the plurality of content blocks comprise a first set of content blocks corresponding to a first day and a second set of content blocks corresponding to a second day; and
generating the set of content blocks such that the set of content blocks are aligned linearly comprises arranging the first set of content blocks and the second set of content blocks in a calendar structure.

15. The system of claim 14, wherein the operations further comprise:
receiving selection of a content block from the first set of content blocks; and
responsive to receiving the selection of the content block, obscuring the second set of content blocks on the graphical user interface.

16. A non-transitory computer-readable medium having program code that is stored thereon, the program code executable by one or more processing devices for performing operations comprising:
receiving user-defined content data for each of a plurality of content blocks, the user-defined content data including at least one respective piece of content for each of the plurality of content blocks and a respective time constraint for each of the plurality of content blocks;
generating a graphical user interface that includes the plurality of content blocks by arranging the plurality of content blocks according to each respective time constraint such that:
each of the plurality of content blocks is sized according to the respective time constraint; and
the plurality of content blocks are arranged in a calendar structure;
configuring each of the plurality of content blocks to launch a presentation element configured to display the at least one respective piece of content; and
providing the graphical user interface for display on a computing device.

17. The non-transitory computer-readable medium of claim 16, wherein the operations further comprise causing the computing device to automatically progress through each of the plurality of content blocks according to the calendar structure by launching the presentation element to display the at least one respective piece of content for each individual content block of the plurality of content blocks sequentially based on the respective time constraint such that the presentation element displays the at least one respective piece of content at a time that corresponds to the calendar structure.

18. The non-transitory computer-readable medium of claim 16, wherein:
the calendar structure comprises a first linear set of content blocks and a second linear set of content blocks; and
the operations further comprise:
receiving, via the graphical user interface, selection of a particular content block of the plurality of content blocks;
in response to receiving the selection:
modifying the graphical user interface to include the presentation element;
identifying a linear set of content blocks that includes the particular content block;
determining that the particular content block is in the first linear set of content blocks; and
in response to determining that the particular content block is in the linear set of content blocks, obscuring the second linear set of content blocks from the graphical user interface and positioning the first linear set of content blocks adjacent the presentation element.

19. The non-transitory computer-readable medium of claim 18, wherein obscuring the second linear set of content blocks comprises removing the second linear set of content blocks from the graphical user interface.

20. The non-transitory computer-readable medium of claim 18, wherein the first linear set of content blocks are arranged in at least one or a horizontal row or a vertical column.
